(19) United States
(12) Patent Application Publication
(10) Pub. No.: US 2024/0278819 A1
(43) Pub. Date: Aug. 22, 2024

(54) PALLETLESS DELIVERY SYSTEM

(71) Applicant: Rehrig Pacific Company, Los Angeles, CA (US)

(72) Inventors: Dane Gin Mun Kalinowski, Foothill Ranch, CA (US); Derick Foster, Cumming, GA (US); Peter Douglas Jackson, Alpharetta, GA (US); Travis James Englert, Brea, CA (US)

(21) Appl. No.: 18/441,277

(22) Filed: Feb. 14, 2024

Related U.S. Application Data
(60) Provisional application No. 63/542,415, filed on Oct. 4, 2023.
(60) Provisional application No. 63/446,538, filed on Feb. 17, 2023.

(51) Int. Cl. B62B 3/06; B62B 3/00

(52) U.S. Cl. CPC B62B 3/0612; B62B 3/00; B62B 2203/07

(57) ABSTRACT

A lift includes a platform having a plurality of rollers for supporting a load thereon. A plurality of wheels support the platform. A build platform may include a platform having a plurality of rollers for supporting a load thereon. The rollers of the build platform may be driven by the rollers of the lift.

### BACKGROUND

Pallets are often used to transport many items from warehouses to stores. The pallets are loaded with the items in the warehouse. Pallet jacks or lifts are used to move the loaded pallets from the warehouse to a truck and from the truck into the store. In some applications, the items are then unloaded from the pallet inside the store. For example, a worker may move the items from the pallet to shelves in a store.

### SUMMARY

In some aspects, the techniques described herein can be used to provide a palletless delivery system, eliminating the need for pallets in some environments. They system can also be used in environments where pallets are not normally used.

In some aspects, the techniques described herein relate to a lift including: a platform, the platform including a plurality of rollers; and a plurality of wheels supporting the platform.

In some aspects, the techniques described herein relate to a lift wherein the plurality of rollers are powered to move a load placed thereon.

In some aspects, the techniques described herein relate to a lift wherein the plurality of wheels includes a pair of load wheels each rotatable about a horizontal load wheel axis, wherein the plurality of rollers each are rotatable about a horizontal roller axis.

In some aspects, the techniques described herein relate to a lift wherein the plurality of rollers includes a first roller having a hub motor therein.

In some aspects, the techniques described herein relate to a lift wherein the plurality of rollers are interconnected such that each of the plurality of rollers is rotatably coupled to an adjacent one of the plurality of rollers.

In some aspects, the techniques described herein relate to a lift in combination with a plurality of objects supported on the plurality of rollers.

The plurality of objects may directly contact the plurality of rollers.

In some aspects, the techniques described herein relate to a lift wherein the plurality of rollers includes a forward-most roller offset downwardly relative to at least a subset of the plurality of rollers, which are substantially coplanar.

In some aspects, the techniques described herein relate to a lift further including a lower structure, wherein the plurality of wheels include load wheels supporting the lower structure, wherein the platform is pivotable relative to the lower structure, the lift further including a tilt actuator configured to pivot the platform relative to the lower structure.

In some aspects, the techniques described herein relate to a lift further including: a base, the lower structure extending forward of the base; and a backrest fixed relative to the platform, the base pivotably connected to the base at a backrest axis spaced vertically higher than the platform.

In some aspects, the techniques described herein relate to a lift wherein the lower structure includes a rear portion extending substantially horizontally from the base and a forward portion angling downward from a forward end of the rear portion.

In some aspects, the techniques described herein relate to a lift wherein the plurality of wheels includes a rear wheel, the lift further including a tiller arm configured to pivot the rear wheel about a vertical axis.

In some aspects, the techniques described herein relate to a lift further including a hub motor within the rear wheel.

In some aspects, the techniques described herein relate to a lift wherein the plurality of wheels includes a rear wheel, the lift further including a tiller arm configured to pivot the rear wheel about a vertical axis.

In some aspects, the techniques described herein relate to a lift wherein the plurality of rollers includes a forward-most roller offset downwardly relative to at least a subset of the plurality of rollers, which are substantially coplanar.

In some aspects, the techniques described herein relate to a build platform including: a base; and a plurality of rollers rotatably supported on the base, each of the plurality of rollers rotatable about its longitudinal axis, wherein each longitudinal axis of the plurality of rollers is parallel to one another, wherein the plurality of rollers are configured to rotate together in a same rotational direction.

In some aspects, the techniques described herein relate to a build platform wherein the plurality of rollers are free-spinning about their longitudinal axes.

In some aspects, the techniques described herein relate to a build platform wherein the plurality of rollers are interconnected such that each of the plurality of rollers is rotatably coupled to an adjacent one of the plurality of rollers.

In some aspects, the techniques described herein relate to a build platform further including a drive roller positioned at a forward end of the build platform below a forward-most one of the plurality of rollers, wherein the drive roller rotatably engages the forward-most one of the plurality of rollers.

In some aspects, the techniques described herein relate to a build platform in combination with a lift having a lift platform including a forward-most roller and a plurality of wheels supporting the platform, wherein the forward-most roller is configured to rotatably engage the drive roller of the build platform, such that rotation of the forward-most roller of the lift causes rotation of the plurality of rollers of the build platform.

In some aspects, the techniques described herein relate to a method for loading a lift including: a) moving a lift into a position adjacent a build platform having a plurality of rollers supporting at least one item thereon; and b) causing the plurality of rollers to rotate, thereby causing the at least one item to move from the build platform to the lift.

In some aspects, the techniques described herein relate to a method wherein the lift causes the plurality of rollers on the build platform to rotate.

In some aspects, the techniques described herein relate to a method further including providing energy from the lift to the plurality of rollers on the build platform to rotate.

In some aspects, the techniques described herein relate to a method further rotatably driving a drive roller of the build platform, wherein the drive roller is rotatably coupled to the plurality of rollers on the build platform.

In some aspects, the techniques described herein relate to a method further including: c) after step b), moving the at least one item with the lift; and d) after step d), pivoting a support platform of the lift to place the at least one item on a floor.

In some aspects, the techniques described herein relate to a method for moving at least one item with a lift including: (a) placing the at least one item on a plurality of rollers on the lift; (b) moving the at least one item with the lift; (c) tilting the plurality of rollers relative to gravity; and (d) causing the plurality of rollers to rotate to move the at least one item off the lift.

In some aspects, the techniques described herein relate to a method wherein the at least one item is placed directly on the rollers in step a).

In some aspects, the techniques described herein relate to a method wherein step b) includes rolling the lift.

In some aspects, the techniques described herein relate to a method wherein step d) is performed by a motor.

### BRIEF DESCRIPTION OF THE DRAWINGS

FIG. 1 is a front perspective view of a lift according to a first example embodiment, with the platform in a lowered position.

FIG. 2 is a rear perspective view of the lift of FIG. 1.

FIG. 3 is a top view of the lift of FIG. 1.

FIG. 4 is a bottom view of the lift of FIG. 1.

FIG. 5 is a bottom view of the lift of FIG. 1 without the lower structure.

FIG. 6 is a front view of the lift of FIG. 1.

FIG. 7 is a rear view of the lift of FIG. 1.

FIG. 8 is a side view of the lift of FIG. 1.

FIG. 9 is a front perspective view of the lift of FIG. 1 with the platform in a raised position.

FIG. 10 is a rear perspective view of the lift of FIG. 9.

FIG. 11 is a side view of the lift with the platform in the raised position.

FIG. 12 is a top view of the base and the tiller arm of the lift of FIG. 1.

FIG. 13 is a side view of the lift with the platform in the lowered position either loading or unloading a plurality of items on a floor.

FIG. 14 shows the lift with the plurality of items supported on the platform.

FIG. 15 shows the lift supporting the plurality of items with the platform in a raised position.

FIG. 16 shows a palletless delivery system according to a second embodiment.

FIG. 17 is a rear perspective view of the lift of FIG. 16.

FIG. 18 is a front perspective view of the lift of FIG. 16.

FIG. 19 is a top view of the lift of FIG. 16.

FIG. 20 is a bottom view of the lift of FIG. 16.

FIG. 21 is a bottom view of the lift of FIG. 16 without the lower structure.

FIG. 22 is a front view of the lift of FIG. 16.

FIG. 23 is a rear view of the lift of FIG. 16.

FIG. 24 is a side view of the lift of FIG. 16 engaging a loaded build platform of FIG. 16.

FIG. 25 shows the items on the build platform being transferred to the lift of FIG. 24.

FIG. 26 shows the items transferred to the lift of FIG. 24.

FIG. 27 shows the lift of FIG. 26 with the platform tilted back to retain the items.

FIG. 28 shows the lift and a plurality of build platforms of FIG. 16 in a warehouse having the plurality of items.

FIG. 29 shows the lift approaching the loaded build platform of FIG. 28.

FIG. 30 shows a front end of the lift engaging the loaded build platform of FIG. 28.

FIG. 31 shows the items being transferred from the build platform to the lift of FIG. 28.

FIG. 32 shows the items completely transferred from the build platform to the lift of FIG. 28.

FIG. 33 shows the items on the lift of FIG. 28, with the platform tilted back.

FIG. 34 is a side view of the lift with the items on the platform, with the platform tilted rearward.

FIG. 35 shows the display of the lift of FIG. 34.

FIG. 36 is a side view of the lift of FIG. 34 with the platform tilted forward.

FIG. 37 shows the lift of FIG. 36 in the process of transferring the items to the floor.

FIG. 38 shows the items on the floor and the empty lift.

FIG. 39 is a front perspective view of the build platform of FIG. 16.

FIG. 40 is a front view of the build platform of FIG. 39.

FIG. 41 is a bottom perspective view of the build platform of FIG. 39.

FIG. 42 is a side view of the build platform of FIG. 39.

FIG. 43 is a front perspective view of an alternative build platform.

FIG. 44 shows a quick release pin and bracket for the alternative build platform of FIG. 43.

FIG. 45 is a perspective view of the alternative build platform of FIG. 43 in a stowed position.

FIG. 46 shows the alternative build platform of FIG. 43 with a plurality of items stacked thereon.

### DETAILED DESCRIPTION

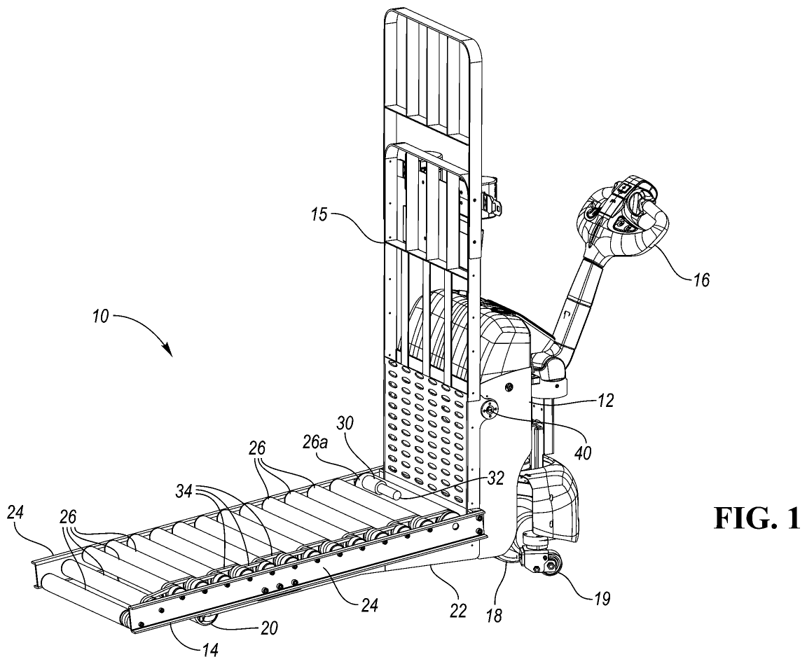

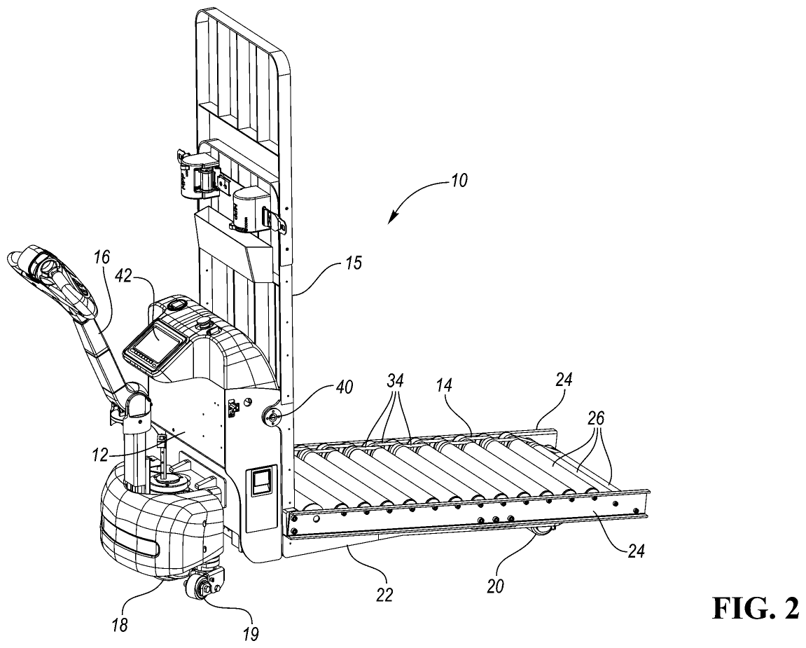

FIGS. 1-15 show palletless delivery system comprising a lift 10 according to a first example embodiment. Referring to FIGS. 1 and 2, the lift 10 includes a base 12 and a platform 14 extending forward from the base 12. A tiller arm 16 is pivotably connected to the base 12 and is used to steer and control the lift 10. A rear wheel 18 is mounted below the base 12 and may be pivoted about a vertical axis by the tiller arm 16. A pair of casters 19 may extend on either side of the rear wheel 18 for increased stability. Load wheels 20 (preferably two, but only one is visible) are mounted to a lower structure 22 that supports the platform 14.

A backrest 15 extends upward from a rear end of the platform 14. The platform 14 and the backrest 15 are secured to one another or formed integrally to form a rigid L-shaped structure, although not necessarily at 90 degrees (in the example shown, the backrest 15 extends from the rear of the platform at approximately 95 degrees). The backrest 15 is pivotably secured to the base 12 at an axis 40. The axis 40 is horizontal, i.e. generally parallel to the floor and parallel to the axes of the load wheels 20. The axis 40 is spaced higher than an upper surface of the platform 14. The axis 40 is spaced above the intersection of the platform 14 and the backrest 15.

The platform 14 includes side beams 24 parallel to one another and spaced apart from one another. A plurality of rollers 26 are mounted between the side beams 24. In this example, the plurality of rollers 26 extend from side beam 24 to side beam 24 and from a leading edge of the platform 14 to the backrest 15. Each roller 26 is rotatable about its longitudinal axis, which extends through each side beam 24 generally parallel to the floor or ground, and generally parallel to the axes of the load wheels 20. As shown, a subset (e.g. two, in this example) of the forward-most rollers 26 are offset downwardly relative to the remainder of the rollers 26, which have uppermost surfaces that are generally coplanar. In this example the first forward-most roller 26 is offset downwardly relative to the second forward-most roller 26, which is in turn offset downwardly relative to the third forward-most roller 26, which is coplanar with the remainder of the rollers 26.

In this embodiment, the side beams 24 are recessed slightly downward from the uppermost surfaces of the rollers 26. This permits objects that are wider than the rollers 26 to be placed on top of the rollers 26. Alternatively, the side beams 24 could extend upward higher than the uppermost surfaces of the rollers 26 to provide increased stability to the objects placed thereon.

A motor 30 may optionally be provided to drive the rollers 26 rotatably about their long axes. The motor 30 may be coupled to one or more gearsets, such as a planetary gearset 32, in a hub motor assembly. As shown, the motor 30 may be positioned inside one of the rollers 26a, such as the roller 26a adjacent the backrest 15. The rear-most roller 26a in this example has a larger diameter than the other rollers 26 (in this example, 3″ versus 2″) to accommodate the hub motor assembly, but the roller 26a could be the same size as the other rollers 26. Alternatively, the motor 30 could be positioned within one of the other rollers 26.

The rollers 26 may be interconnected by elastomeric bands 34, as shown. Alternatively, the rollers 26 may be interconnected via gears, belts, chains, rubber bands, so that all of the rollers 26 are driven together by the motor 30.

Alternatively, the motor 30 may be mounted to the platform 14 adjacent or below the rollers 26 or within the base 12. Optionally, the rollers 26 may be covered by a conveyor belt that encircles the plurality of rollers 26.

Via the motor 30, the rollers 26 can be controlled to rotate forward, backward, hold stationary (brake), or free spin, depending on the situation and is intended to provide a controlled loading, unloading or holding of product (individual cases, stretch wrapped loads, etc.) on the platform 14. This system could be controlled via switches or buttons mounted within the operation controls on the tiller arm 16.

The rear wheel 18 and/or the load wheels 20 may be motorized, such as by having hub motors therein to drive, brake and control the lift 10.

Referring to FIG. 2, a display 42 mounted to the base 12 and facing the user provides a live video stream of the path in front of the lift 10 and, optionally, a user interface for the operator of the lift 10.

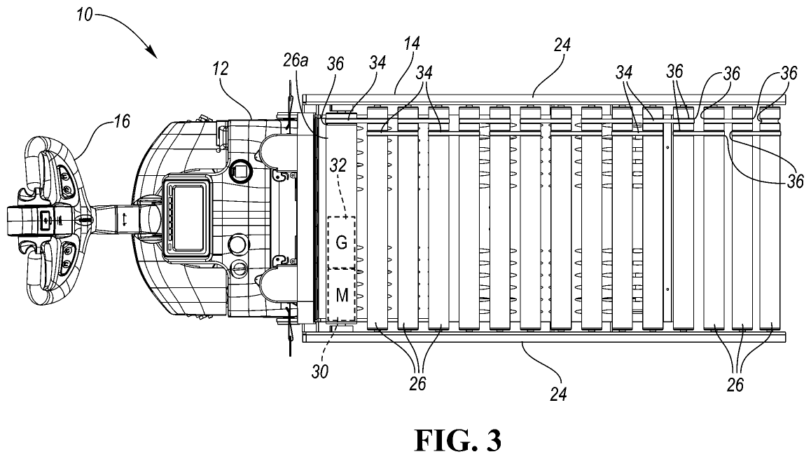

FIG. 3 is a top view of the lift 10. As can be seen more clearly, each of the plurality of rollers 26 is connected to an adjacent one of the plurality of rollers 26 by at least one band 34. Each of the plurality of rollers 26 includes a pair of grooves 36 about its circumference (other than roller 26a, which only needs one groove 36). An elastomeric band 34 is received in each groove 36 and connects each roller 26 to an adjacent roller 26. Each roller 26 (other than the rear-most roller 26a and the forward-most roller 26) is connected to each of two immediately adjacent rollers 26 by one of the bands 34.

When the rear-most roller 26a is driven by the motor 30 and planetary gearset 32, the band 34 rotatably drives the immediately adjacent roller 26, which in turns drives the next roller 26 via another band 34, and so on. In this manner, the plurality of rollers 26 are interconnected such that each of the plurality of rollers 26 is rotatably coupled to an adjacent one of the plurality of rollers 26 and all of the rollers 26 rotate together in the same direction and the same speed. It could be considered that in this embodiment, the rollers 26 are connected in series.

The plurality of rollers 26 could alternatively be interconnected in series by a series of belts, chains or gears. Alternatively, a single belt, band, chain, screw, or gear could drive all of the rollers 26 in parallel.

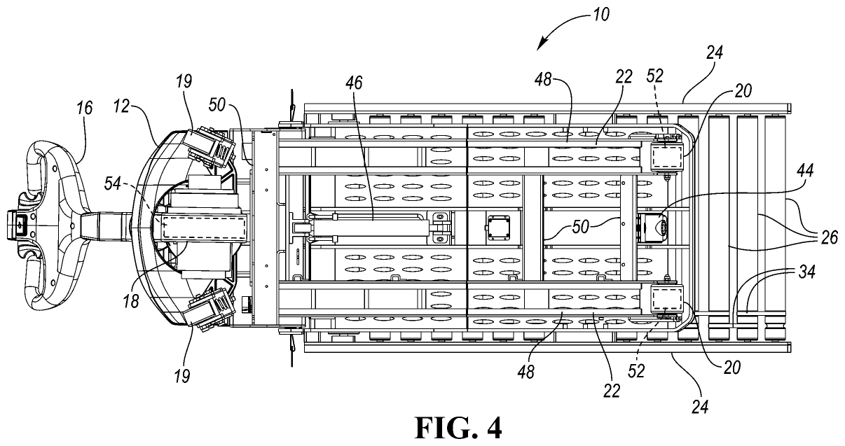

FIG. 4 is a bottom view of the lift 10. A tilt actuator 46 is secured at a forward end to the platform 14 and at a rearward end to the base 12 (or a rearward portion of the lower structure 22). The tilt actuator 46 may be a hydraulic cylinder, electric motor, linear actuator, or other actuator. Manual mechanical devices, such as levers and ratchets, could also be used.

As shown, the lower structure 22 may include a pair of spaced-apart tines 48 extending forward from the base 12. A plurality of cross-beams 50 may connect the tines 48 to one another. A camera 44 may be mounted to a forward-most cross-beam 50. The camera 44 is configured to provide live video of the area in front of the lift 10 to the display 42 (FIG. 2).

FIG. 4 also shows optional hub motor assemblies 52 in each of the load wheels 20. A hub motor assembly 54 may also be included in the rear wheel 18. Alternatively, a standard drive motor (e.g. belt, chain or gear driven) could be provided to power the rear wheel 18. Optionally, the lift 10 may include either the hub motor assemblies 52 in the load wheels 20 or just the a motor driving the rear wheel 18.

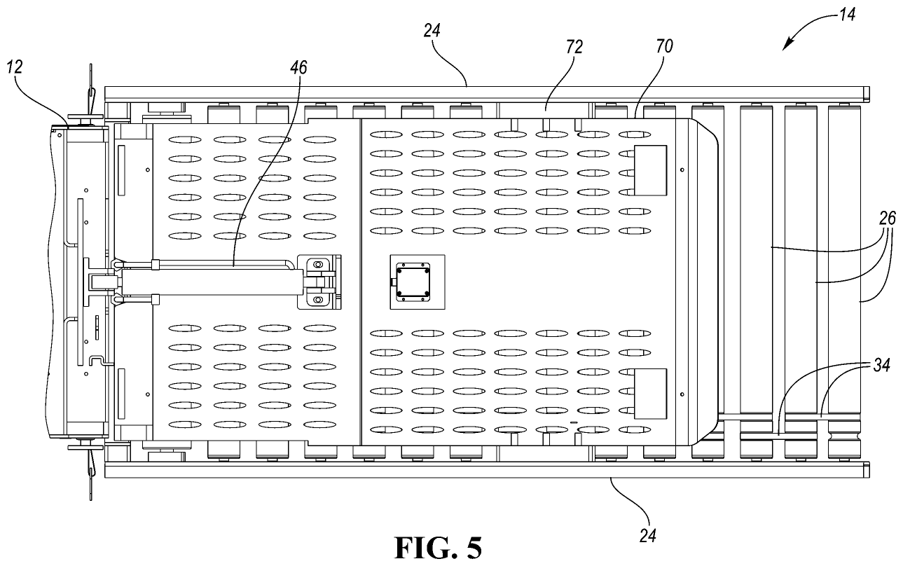

FIG. 5 is a bottom view of the lift 10 without the lower structure 22, to provide a clear view of the bottom of the platform 14. The platform 14 includes a lower plate 70 connected by a beam 72 to side beams 24. The tilt actuator 46 is connected to the base 12 at a rear end and to the lower plate 70 at a forward end.

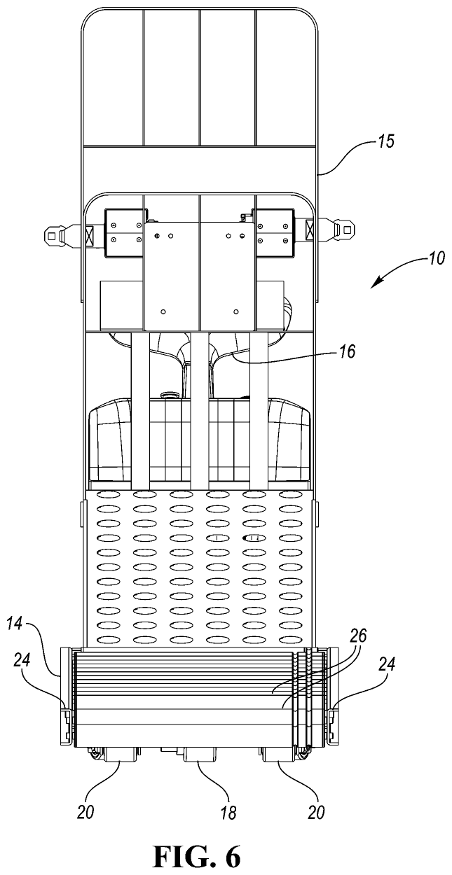

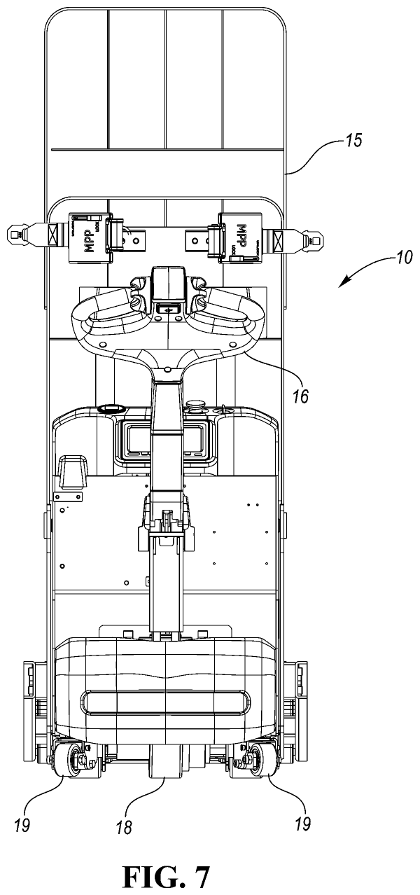

FIG. 6 is a front view of the lift 10. FIG. 7 is a rear view of the lift 10.

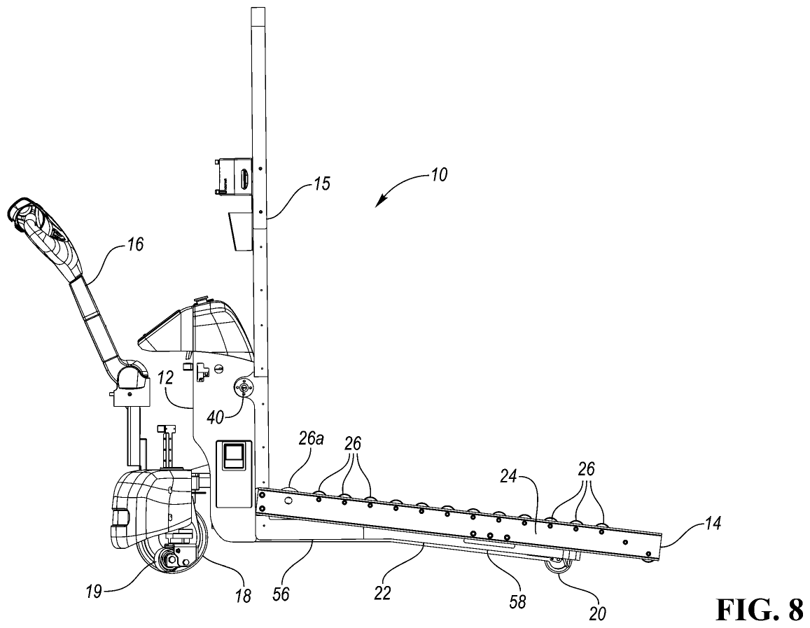

FIG. 8 is a side view of the lift 10. As can be seen in FIG. 8, the lower structure 22 (e.g. the tines) may include a rear portion 56 that extends substantially horizontally (i.e. parallel to the floor) from the base 12 and a forward portion 58 that proceeds at a downward angle (approximately seven degrees) from a forward end of the rear portion 56.

In this example, the rear portion 56 is approximately ⅓ of the length of the lower structure 22 and the forward portion 58 is the remaining approximately ⅔. This improves the clearance when the lift 10 transitions from a horizontal surface (such as the floor of a truck) to a ramp or vice versa.

In FIGS. 1-8, the platform 14 is shown in the lowered position, with the platform 14 tilted forward (relative to a floor) between approximately 5 and approximately 8 degrees. This position could be used to load the platform 14. For example, in the lowered position, a worker could lift the near edge of a box onto the front edge of the platform 14. With the leading edge of the platform 14 is partially under the load, the rollers 26 (FIG. 1) can be powered to pull the load onto the rollers 26 and/or pull the platform 14 under the load. The rear wheel 18 and/or load wheels 20 can also be powered to drive the platform 14 toward/under the load. Alternatively, the load can be lifted and placed onto the rollers 26 and the platform 14.

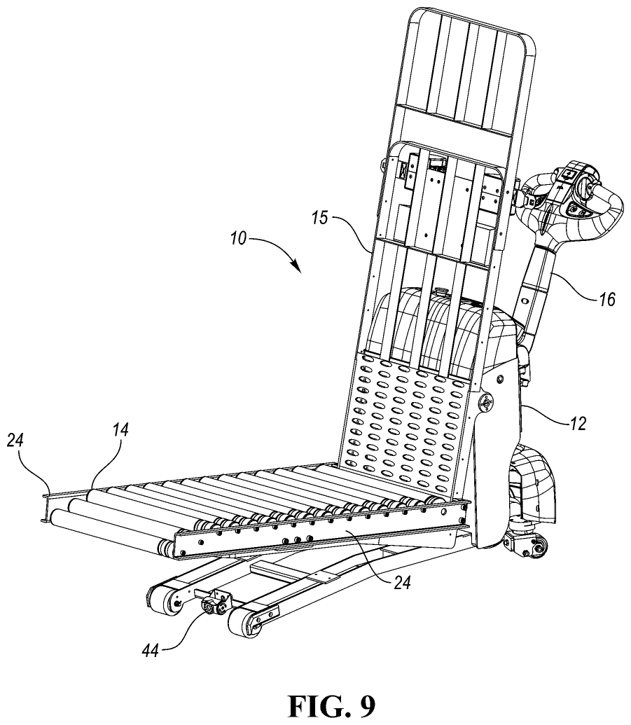

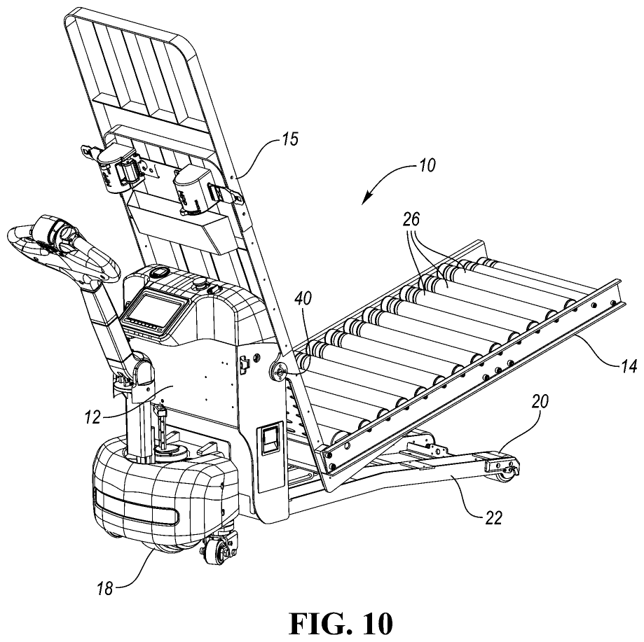

Referring to FIGS. 9 and 10, after the load is on the platform 14, the platform 14 is moved to a raised position via the tilt actuator 46, so that the platform 14 and backrest 15 are tilted rearward as shown. This stabilizes the load on the platform 14. If the rollers 26 are powered, they may be locked against rotation to further stabilize the load. The user then uses the lift 10 to carry the load from the loading area to the truck or from the truck to the store (for example). The camera 44 provides a clear, unobstructed view of the path in front of the lift 10 to the display 42 at the rear of the lift to the user. Alternatively, the load can be carried with the platform 14 in a substantially horizontal position.

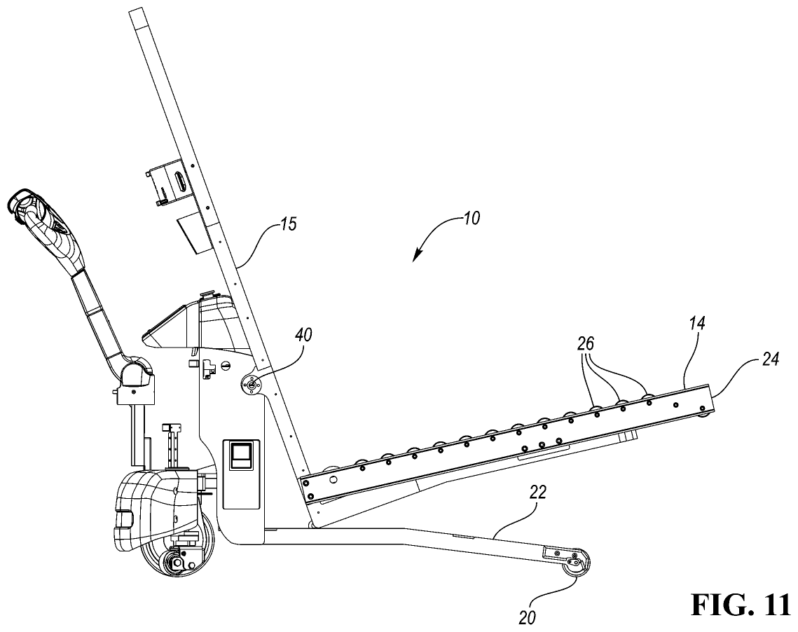

FIG. 11 is a side view of the lift 10 with the platform 14 in the raised position. In this example, the backrest 15 is tilted back approximately twenty degrees relative to vertical, and the platform 14 is tilted rearward between approximately 12 degrees and approximately 15 degrees relative to the floor.

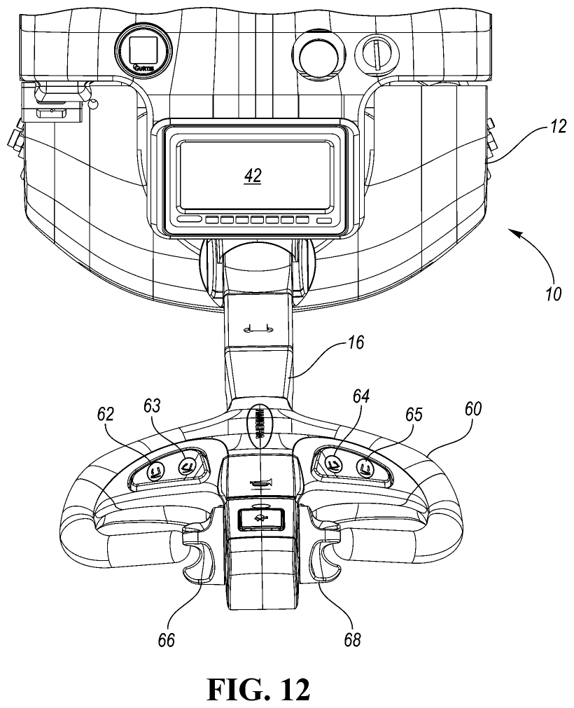

FIG. 12 is a top view of the base 12 and the tiller arm 16. A handle 60 at the end of the tiller arm 16 includes independent controls for the various functions of the lift 10. A roll forward button 63 causes the rollers 26 to roll forward on the platform 14 (i.e. to move goods off the front of the platform 14). A roll rearward button 62 button 62 causes the rollers 26 to roll rearward on the platform 14 (i.e. to move goods onto the platform 14 and toward the backrest 15).

A tilt rearward button 64 causes tilt actuator 46 to expand and tilt the platform 14 rearward (i.e. raise the forward end of the platform 14). A tilt forward button 65 causes the tilt actuator 46 to contract and tilt the platform 14 forward (i.e. lower the forward end of the platform 14).

Rotating either of the rotatable controls 66, 68 forward causes the lift 10 to drive forward. Rotating either of the rotatable controls 66, 68 rearward causes the lift 10 to drive rearward. Rotatable controls 66, 68 each spring-return to a center position in which the wheels are locked in place (or alternatively, free-spinning). Optionally, the speed of the lift is proportional to the amount of rotation of either of the rotatable controls 66, 68. Notably, each of the functions (rotating the rollers, tilting the platform 14 and driving the lift 10) can be controlled independently of one another and can be activated at the same time. Alternatively, or additionally, some sequences of the three functions can be controlled by a processor programmed to execute specific tasks.

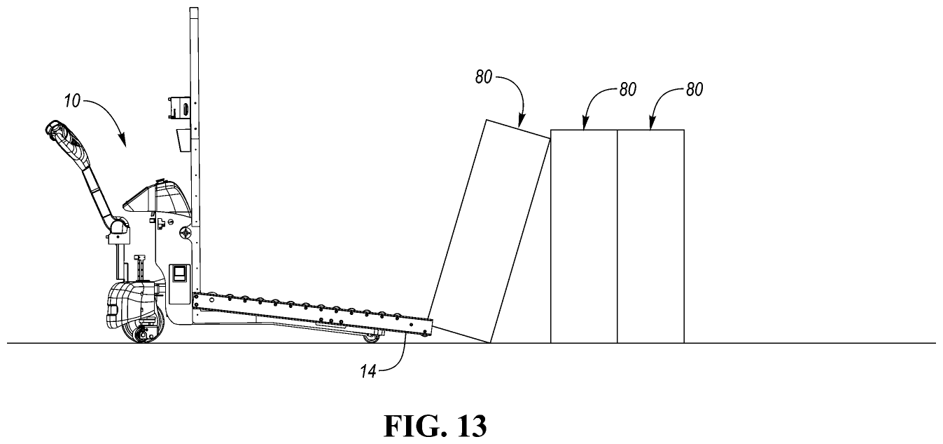

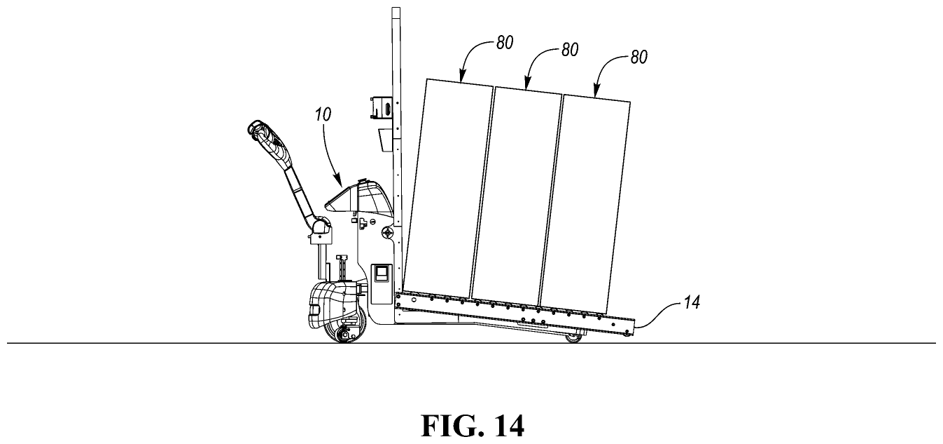

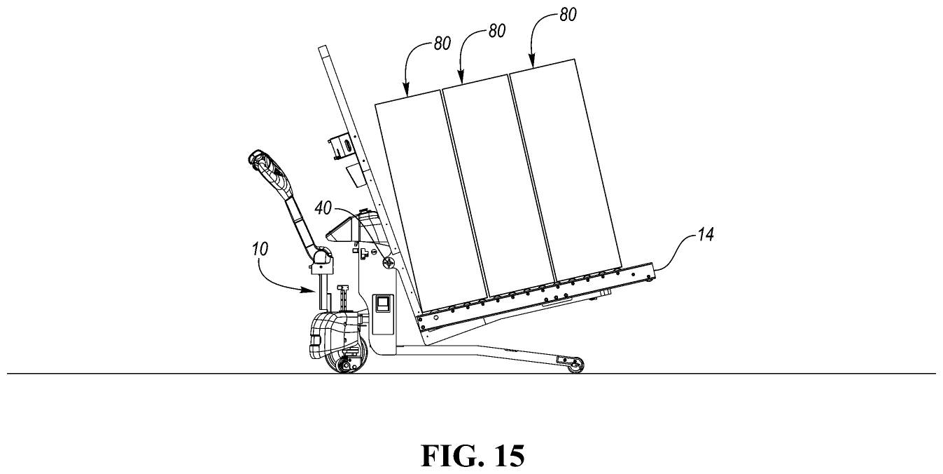

FIG. 13 shows the lift 10 with the platform 14 in the lowered position. The lift 10 may be driven into contact with a first item 80, such as a container, such that the forward-most roller 26 engages the first item 80. The worker may tilt the first item 80 to place the near edge of the first item 80 on the platform 14. The rollers 26 are then rotated rearward to pull the item 80 onto the platform 14. The other items 80 are then brought onto the platform 14 in a similar manner as shown in FIG. 14. The operator may then tilt the platform 14 back to a horizontal position for transport, or alternatively, tilt the platform 14 back a little as shown in FIG. 15, for increased stability.

At the destination (truck, store, restaurant, etc), the lift 10 may be unloaded quickly by first returning the platform 14 to the lowered position of FIG. 14 (by contracting the tilt actuator 46). The rollers 26 are then unlocked so that they can roll freely. The load can roll down the platform 14 on the rollers 26. Alternatively, the operator causes the rollers 26 to roll forward to move the items 80 down the platform 14 at a controlled pace.

FIG. 13 also illustrates the unloaded process. The user may drive the lift 10 rearward as the load rolls off the platform 14. If the rollers 26 are driven forward, they can drive the items 80 off the platform 14 as the lift 10 is moved rearward. The speed of the rollers 26 may be coordinated with the speed with which the lift 10 moves rearward to place the load on the floor as gently and smoothly as possible. These actions could be controlled independently by the operator or as a group of actions performed at the same time via switches or buttons controlled by the operator. A processor in the lift 10 may be programmed to coordinate these functions after receiving a single command from the operator, e.g. driving the lift 10 rearward while driving the rollers 26 to move the items 80 off the platform. Optionally, the processor may also tilt the platform forward 14 first.

The lift 10 increases delivery efficiencies by reducing the amount of time and labor an operator needs to deliver product from the trailer to the store or restaurant. The lift 10 is a compact, fully powered electric lift, but instead of using fork tines to move and transport loaded plastic or wood pallets, the lift utilizes a tilting roller platform 14 to efficiently move and deliver goods without the need for pallets. Instead, the roller platform 14 provides an area to support and transport goods, while also being able to quickly unload the products without having to individually down stack or touch each case.

The lift 10 is compact and highly maneuverable for navigating throughout narrow store aisles and crowded back rooms where deliveries typically occur. The lift 10 is also fully powered for significantly less labor required from the operator to move and deliver heavy loads quickly and efficiently.

While the functionality of the lift 10 is described above within a delivery environment, there are other applications upstream that may also provide value. For example, some warehouses may load loose boxes/packages in a trailer with or without a pallet. This is especially common in the package transport industry, e.g. UPS/FedEx, where cardboard boxes are loosely stacked in the trailer one at a time. The lift 10 could be used in this scenario to load bulk loose boxes quickly and easily in the trailer all at once to reduce the number of box touches. The lift 10 can also be used in many other package or object-handling applications.

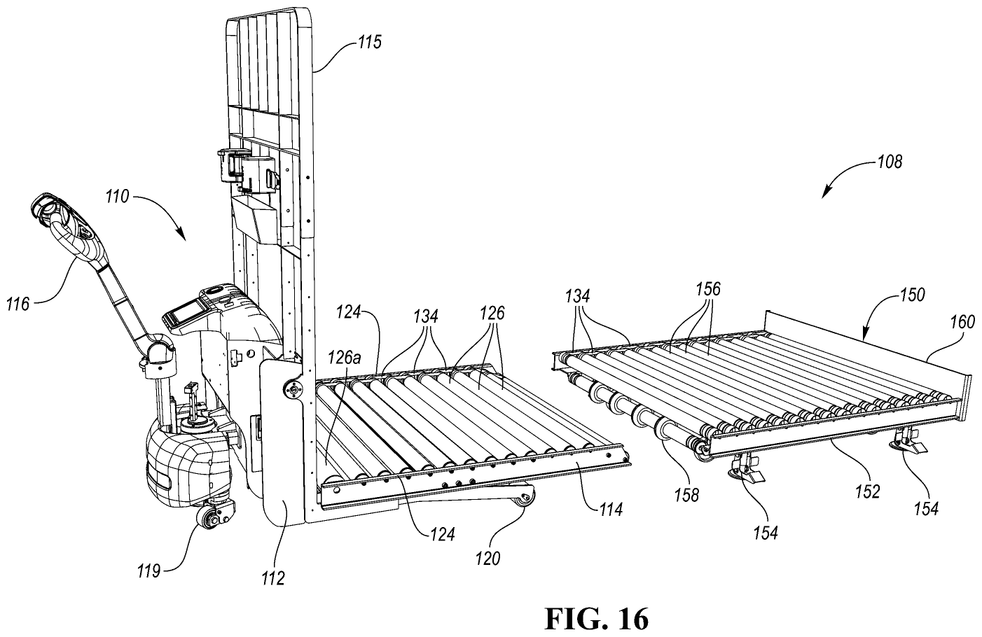

FIG. 16 shows a palletless delivery system 108 according to second embodiment. The palletless delivery system 108 includes a lift 110, which is similar to the lift 10 of the first embodiment except as shown or described. The palletless delivery system 108 also includes at least one build platform 150.

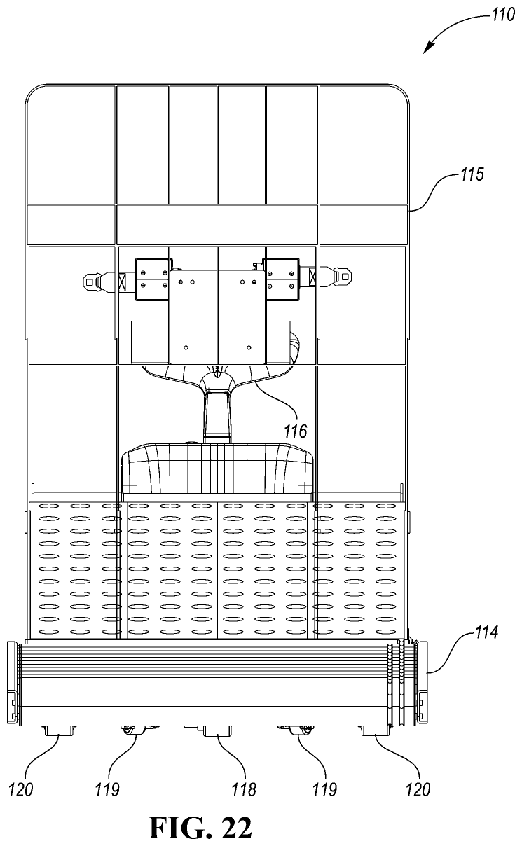

The lift 110 includes a base 112 and a platform 114 extending forward from the base 112. A tiller arm 116 is pivotably connected to the base 112 about a vertical axis and is used to steer and control the lift 110. A rear wheel 118 (FIG. 22) is mounted below the base 112 and may be pivoted by the tiller arm 116. A pair of casters 119 may extend on either side of the rear wheel 118 for increased stability. Load wheels 120 (preferably two, but only one is visible) are mounted to a lower structure 122 that supports the platform 114.

A backrest 115 extends upward from a rear end of the platform 114. The platform 114 and the backrest 115 may be secured to one another or formed integrally to form a rigid L-shaped member as in the first embodiment. The backrest 115 is pivotably secured to the base 112 at an axis 140. The axis 140 is horizontal, i.e. generally parallel to the floor, parallel to the axes of the load wheels 120 and spaced upward from the platform and upward from the intersection of the backrest 115 and platform 114.

The platform 114 includes a plurality of rollers 126. The plurality of rollers 126 are parallel to one another and are each rotatable about its long axis. In this example, the plurality of rollers 126 extend along their long axes from side beam 124 to side beam 124. The plurality of rollers 126 provide the upper surface of the platform 114 from a leading edge of the platform 114 to the backrest 115. Optionally, the rollers 126 may be covered by a conveyor belt that encircles the plurality of rollers 126.

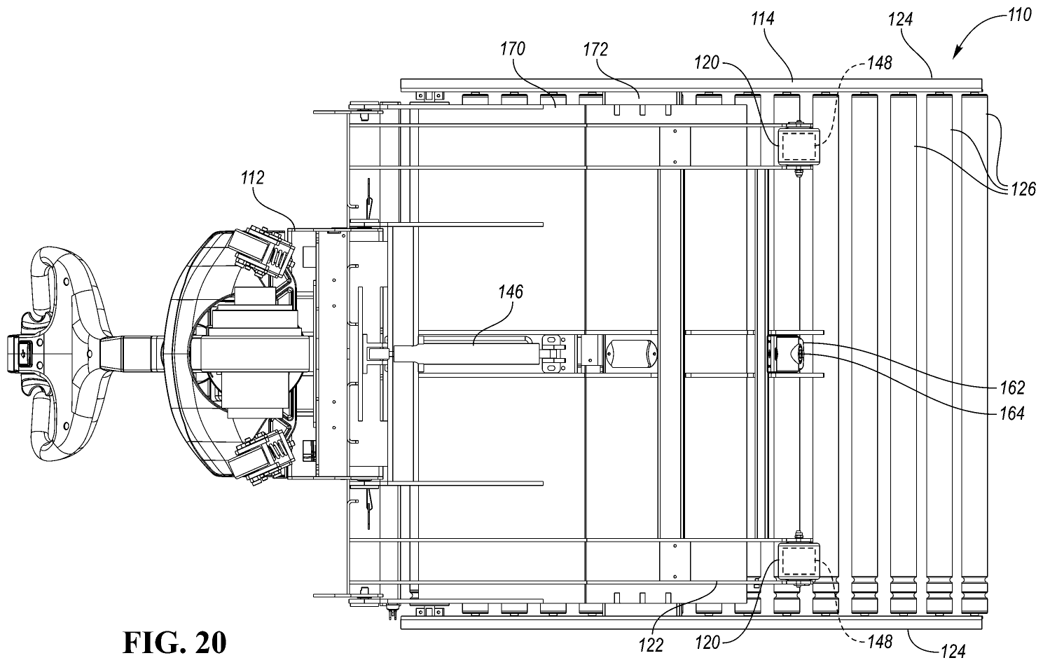

The platform 114 is shorter (front to back) than the platform 14 of the first embodiment. Again, optionally the side beams 124 could protrude above the rollers 126. Otherwise, the lift 110 may be the same as the lift 10, including the tilt actuator 146 (FIG. 20). Other options are described below.

Again, a rear-most roller 126a may contain a motor. The rollers 126 may be interconnected via bands 134 (as before) so that all of the rollers 126 are driven together by the motor 130. Alternatively, one or more of the other rollers 126 may contain a motor.

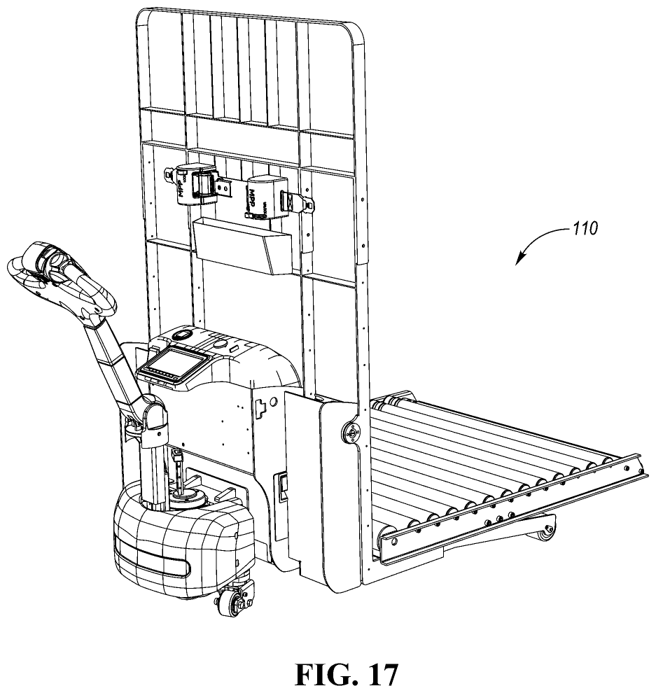

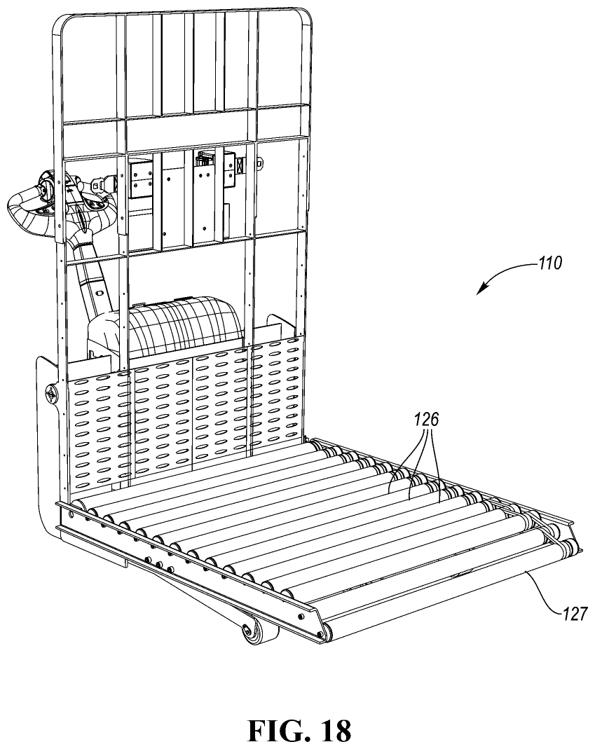

FIGS. 16, 17 and 18 show the platform 114 of the lift 110 in a substantially horizontal position. FIG. 17 is a rear perspective view of the lift 110. FIG. 18 is a front perspective view of the lift 110.

Referring to FIG. 18, a driving roller 127 is positioned at a forward end of the 114 but offset downwardly relative to a plane containing the axes of the rollers 126. The driving roller 127 is driven by the motor 130 in sync with the rollers 126 by one of the bands 134, or optionally via gears, belts, chains, rubber bands, or the like.

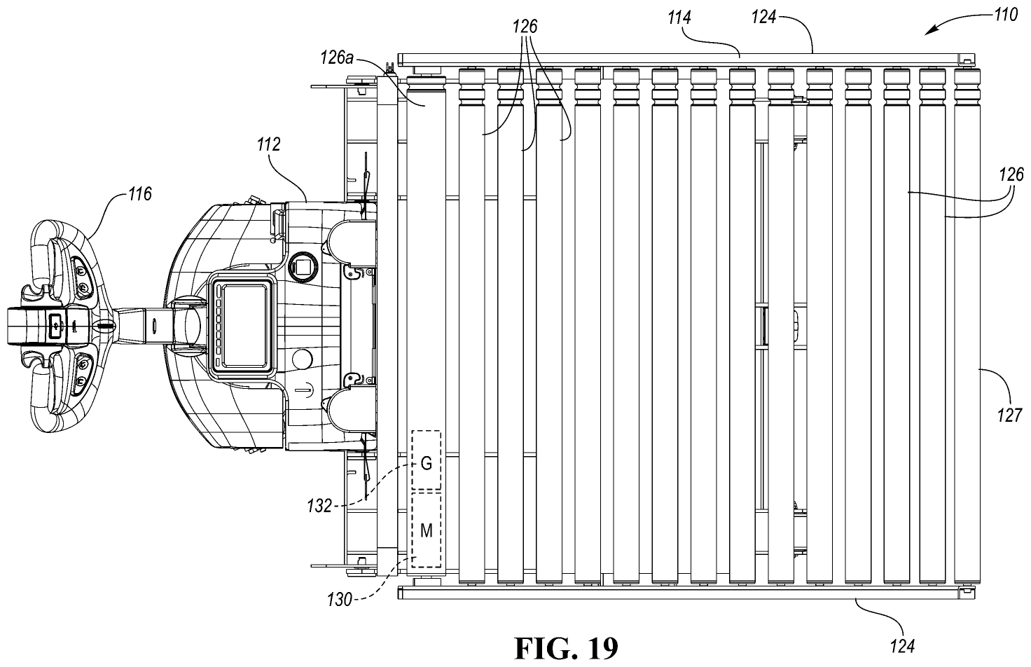

FIG. 19 is a top view of the lift 110. Referring to FIG. 19, the motor 130 may be positioned inside one of the rollers 126, such as the roller 126a adjacent the backrest 115. The motor 130 may be coupled to one or more gearsets, such as a planetary gearset 132, in a hub motor assembly. Again, the other rollers 126 may be driven by the motorized roller 126. Alternatively, the motor 130 may be mounted to the platform 114 adjacent or below the rollers 126 or within the base 112 and connected to the rollers 126 by gears, belts, chains, rubber bands, or the like.

The rollers 126 can be controlled to rotate forward, backward, hold stationary (brake), or free spin, depending on the situation and is intended to provide a controlled loading, unloading or holding of product (individual cases, stretch wrapped loads, etc.) on the platform 114. This system could be controlled via switches or buttons mounted within the operation controls on the tiller arm 116, identical to those in FIG. 12 for the first embodiment.

Referring again to FIG. 16, the build platform 150 includes a base 152 and a plurality of legs 154 supporting the base 152 above the floor. A plurality of rollers 156 provide the upper surface of the base 152. The plurality of rollers 156 are free-spinning about their long axes but they are interconnected by bands 134. Alternatively, the rollers 156 could be interconnected by gears, chains, rubber bands, or the like to one another. In this manner, the plurality of rollers 156 are rotatably coupled to one another.

A forward-most one of the plurality of rollers 156 engages a drive roller 158, such that rotation of the drive roller 158 in one direction causes the plurality of rollers 156 to rotate in the opposite direction The drive roller 158 is positioned at a front end of the build platform 150 below the forward-most roller 156. In this example shown, a plurality of elastomeric rings around the drive roller 158 contact the forward-most roller 156 to provide a rotatable counterdriving coupling therebetween.

Alternatively, one of the rollers 156 could be powered by a motor, such as a hub motor therein, and drivingly engage the other rollers 156 as above. The rollers 156 could be controlled by the operator and/or by the lift 110 (such as a wireless signal from the lift 110).

The build platform 150 may include a rear wall 160 projecting upward from a rear edge of the base 152 higher than the plurality of rollers 156. Optionally, the rollers 156 may be covered by a conveyor belt that encircles the plurality of rollers 156.

FIG. 20 is a bottom view of the lift 110. The platform 114 includes a lower plate 170 connected by a beam 172 to side beams 124. The tilt actuator 146 is connected to the base 112 at a rear end and to the lower plate 170 at a forward end. The tilt actuator 146 may be a hydraulic cylinder, electric motor, linear actuator, or other actuator. Manual mechanical devices, such as levers and ratchets, could also be used.

Each of the load wheels 120 may contain a hub motor 148. The lower structure 122 includes a pair of spaced apart tines connected by cross-beams. The camera 164 and headlight 162 may be mounted to the forward-most cross-beam.

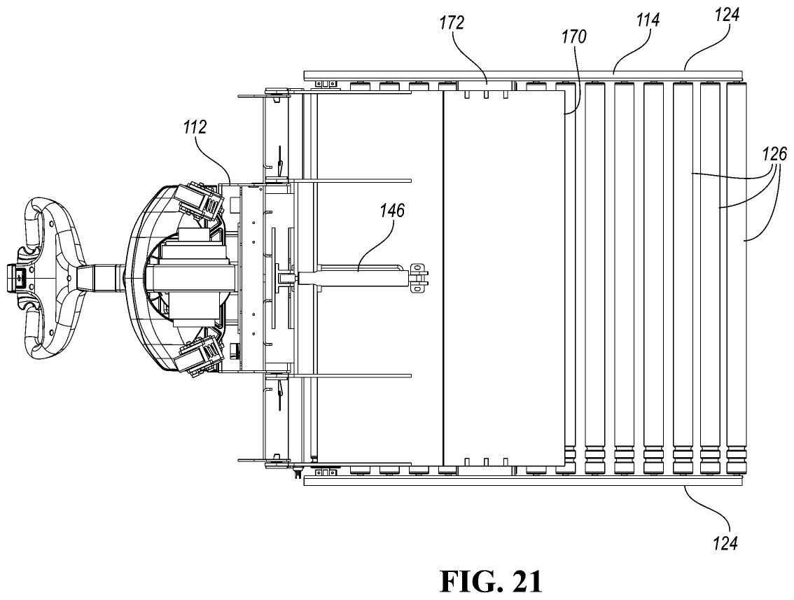

FIG. 21 is a bottom view of the lift 110 without the lower structure 122. The platform 114 includes a lower plate 170 connected by a beam 172 to side beams 124. The tilt actuator 146 is connected to the base 112 at a rear end and to the lower plate 170 at a forward end. Each of the load wheels 120 may contains a hub motor 148.

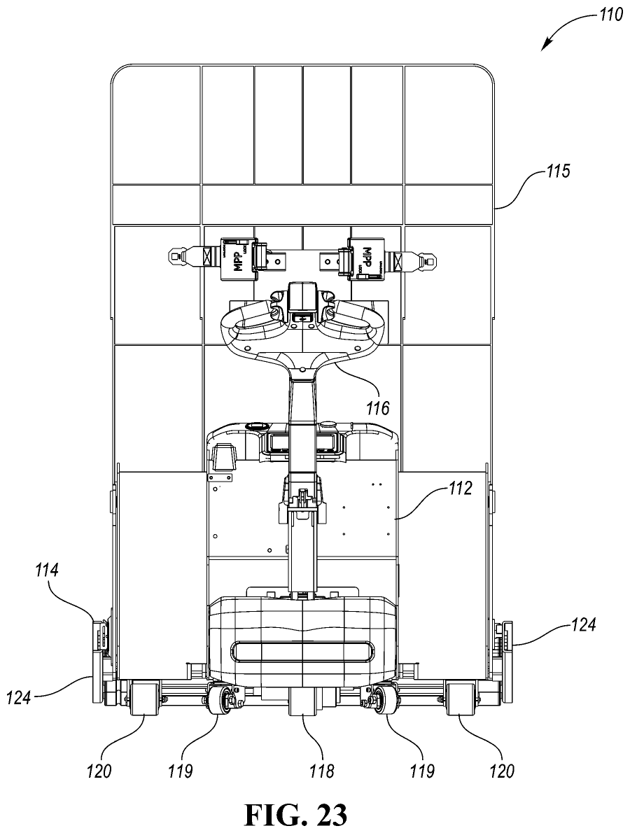

FIG. 22 is a front view of the lift 110. FIG. 23 is a rear view of the lift 110.

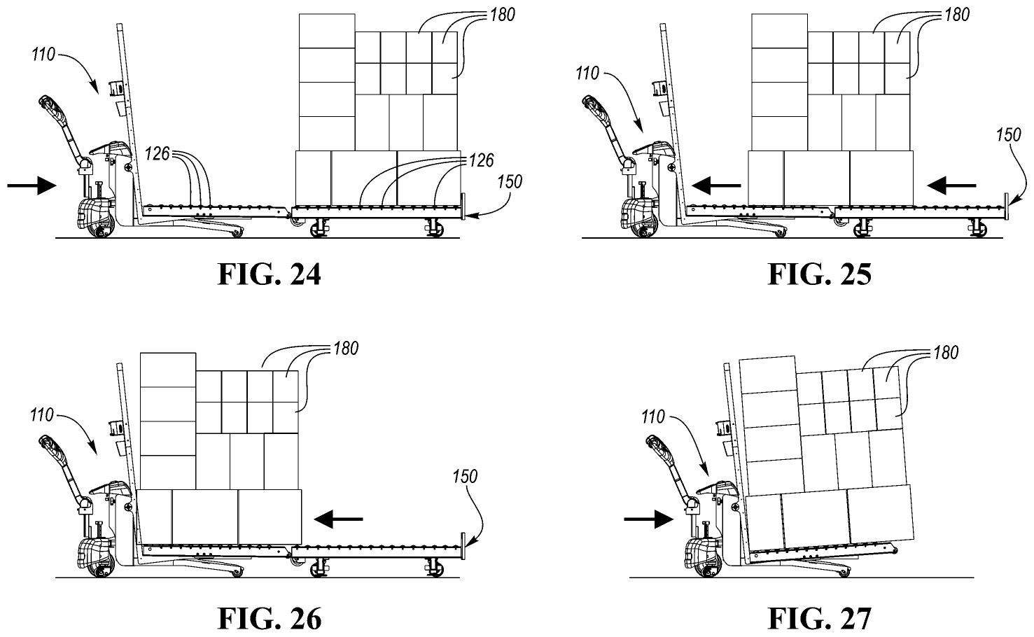

FIGS. 24-28 demonstrate usage of the palletless delivery system 108. Referring to FIG. 24, a plurality of items 180, such as boxes, packages or products, are stacked on the build platform 150 by a worker, such as a warehouse or distribution center worker. When the stack is complete (e.g. a complete order or a portion thereof is assembled on the build platform 150), the forward end of the lift 110 is brought into contact with the forward end of the build platform 150. The driving roller 127 of the lift 110 engages the drive roller 158 of the build platform 150.

Referring to FIG. 25, the user then engages the motor 130 to spin in a first direction (such as by pressing the roll rearward button 62 of FIG. 12), which causes the upper surfaces of the rollers 126 to move toward the backrest 115. The driving roller 127 also rotates in the same first direction, which causes the drive roller 158 to rotate in the opposite direction, which in turn causes the plurality of rollers 156 to rotate in the first direction, i.e. the upper surfaces of the plurality of rollers 156 to move toward the lift 110. As shown, this causes the plurality of items 180 to move from the build platform 150 onto the rollers 126 of the lift 110. Of course, the plurality of items 180 could also be moved from the lift 110 onto the build platform 150 by reversing the motor 130.

In FIG. 26, the plurality of items 180 have been moved onto the platform 114 of the lift 110, at which time the motor 130 is disengaged (either automatically or manually). Referring to FIG. 27, the platform 114 may then be tilted rearwardly via the tilt rearward button 64 (FIG. 12) and the tilt actuator 146 (not visible). The plurality of items 180 may rest against the backrest 115. The user then drives the lift 110 toward a truck (or other destination).

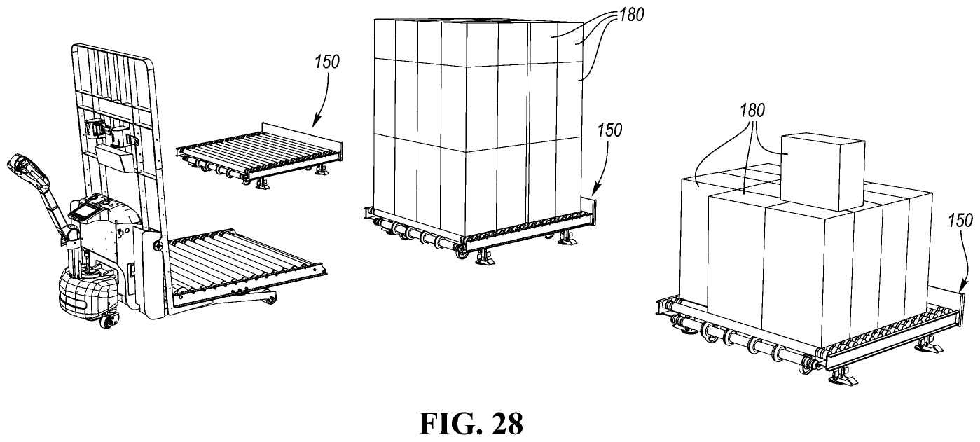

FIGS. 28 to 36 also illustrate use of the palletless delivery system 108. FIG. 28 shows a plurality of build platforms 150 in a warehouse having the plurality of items 180. As shown, one build platform 150 is empty, another is currently being loaded with plurality of items 180, and the middle build platform 150 is completely stacked with plurality of items 180.

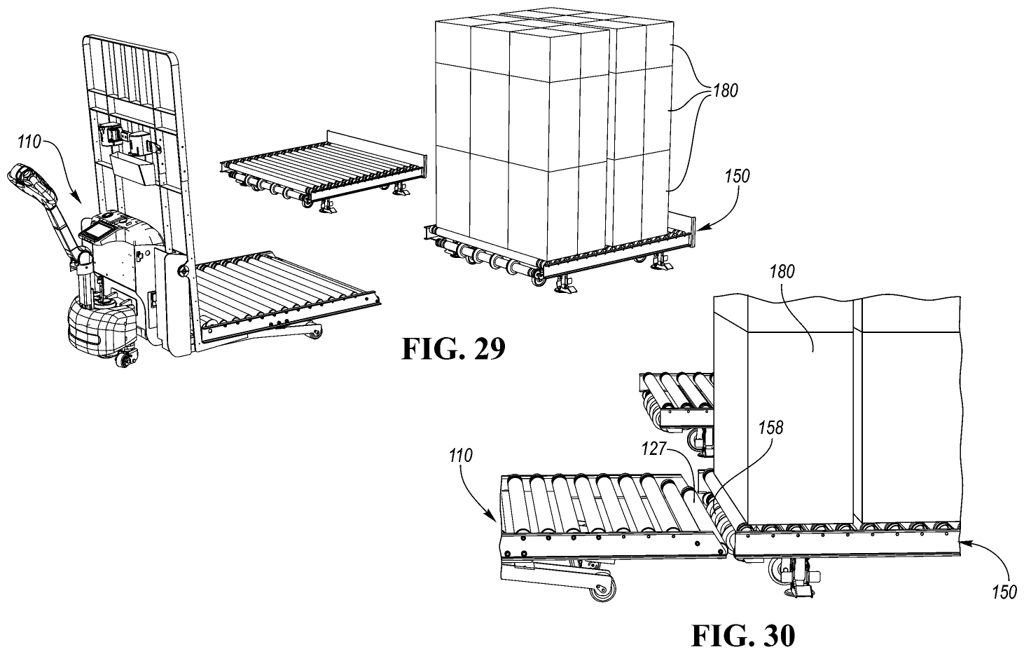

In FIGS. 29 and 30, a worker brings the lift 110 toward the loaded build platform 150. The driving roller 127 engages the drive roller 158 in FIG. 30.

Referring to FIG. 31, the user then engages the motor 130 to spin in a first direction (such as by pressing the roll rearward button 62 button 62 of FIG. 12), which causes the upper surfaces of the rollers 126 to move toward the backrest 115. The driving roller 127 also rotates in the same first direction, which causes the drive roller 158 to rotate in the opposite direction, which in turn causes the plurality of rollers 156 to rotate in the first direction, i.e. the upper surfaces of the plurality of rollers 156 to move toward the lift 110. As shown, this causes the plurality of items 180 to move from the build platform 150 onto the rollers 126 of the lift 110.

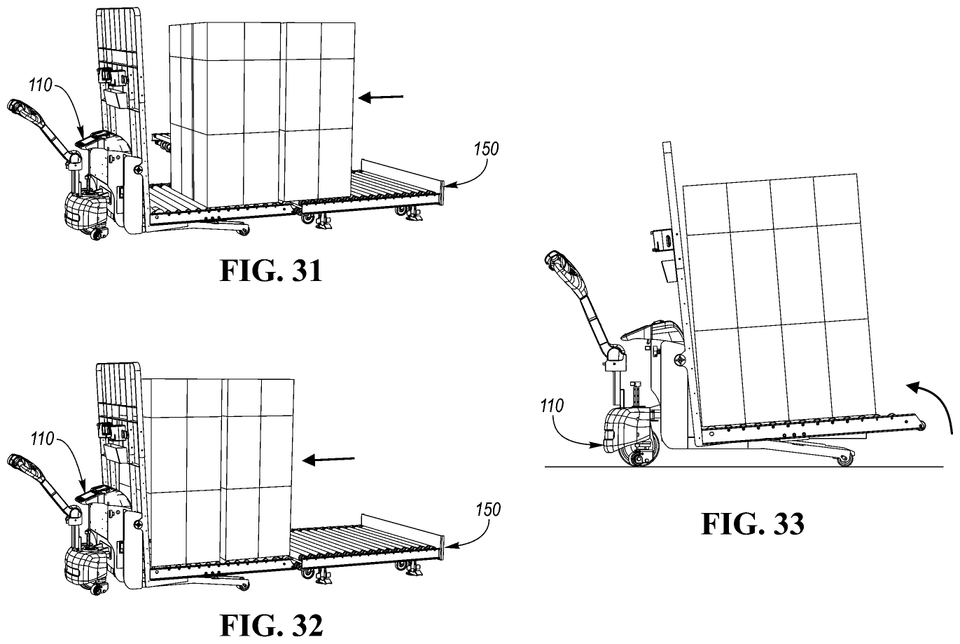

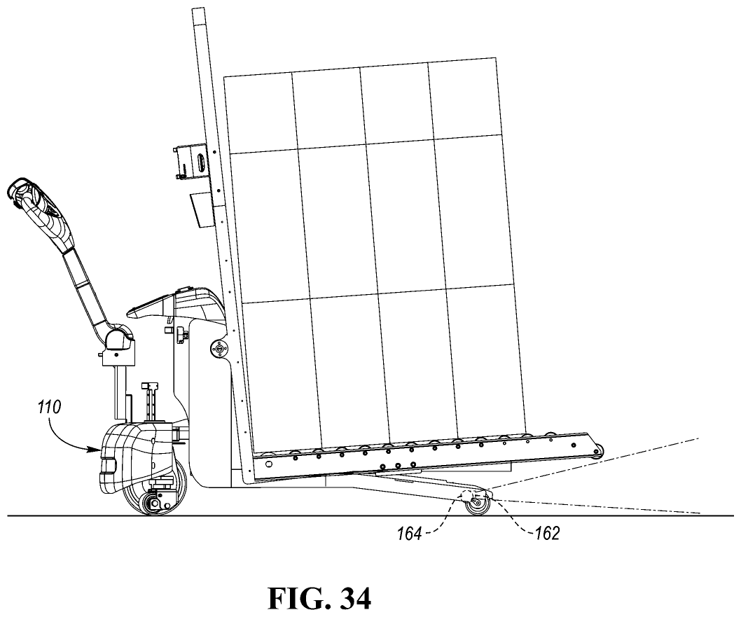

In FIG. 32, the plurality of items 180 have been moved onto the platform 114 of the lift 110, at which time the motor 130 is disengaged (either automatically or manually). Referring to FIG. 33, the platform 114 may then be tilted rearwardly via the tilt rearward button 64 (FIG. 12) and the tilt actuator 146 (not visible). The plurality of items 180 may rest against the backrest 115. The user then drives the lift 110 toward a loading dock and a truck (or other destination). FIG. 34 is a side view of the lift 110 with the items 180 on the platform 114, with the platform 114 tilted rearward. In this configuration, the worker can move the lift 110 through a loading dock door and onto a truck.

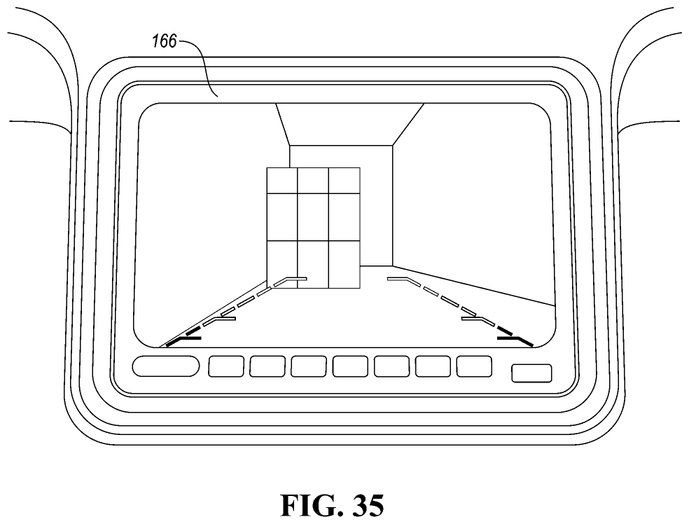

As shown in FIGS. 34 and 35, the front of the base 112 of the lift 110 may be provided with a headlight 162 to illuminate the area in front of the lift 110 and a camera 164. The camera 164 provides a live video image of the area in front of the lift 110 on a display 166 on the tiller arm 116 as shown in FIG. 35.

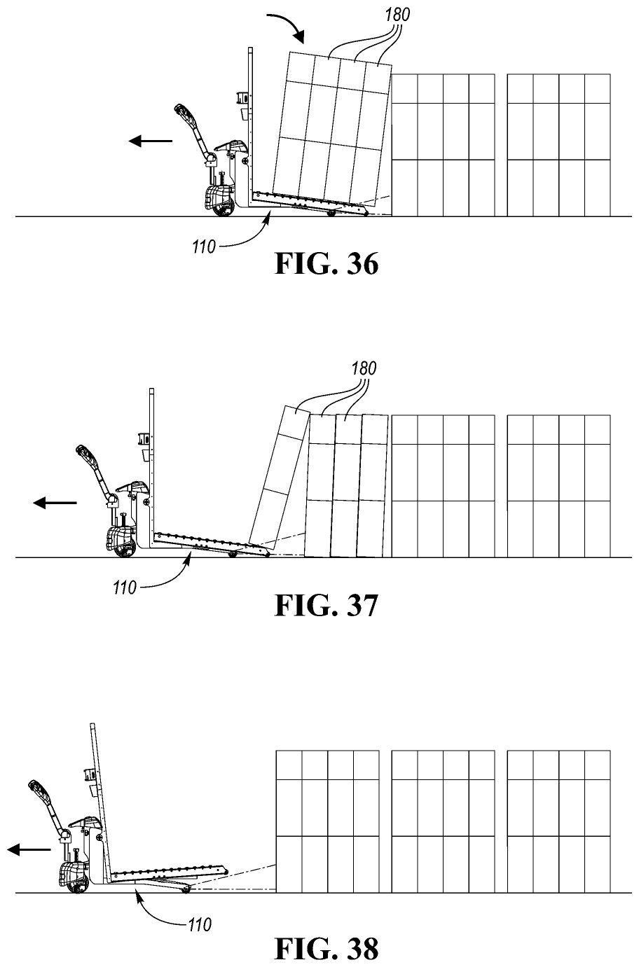

Referring to FIG. 36, the worker then presses the tilt forward button 65 (FIG. 12) which causes the lift 110 to pivot the platform 114 forward. Then the worker presses the roll forward button 63 (FIG. 12) to drive the rollers 126 in a second direction, opposite the first direction, in which the upper surfaces of the rollers 126 move away from the backrest 115. This causes the plurality of items 180 to move forward off the platform 114. At the same time, the worker rotates one of the rotatable controls 66, 68 rearward, which commands a hub motor in the rear wheel 118 (or standard drive motor driving the rear wheel 118 via a belt, chain or gear and/or hub motors 148 in the load wheels 120) to move the lift 110 rearward so that the plurality of items 180 can be placed relatively gently on the floor of the truck, as shown in FIG. 37.

Referring to FIG. 38, the user then takes the lift 110 back into the warehouse to retrieve another stack of the plurality of items 180.

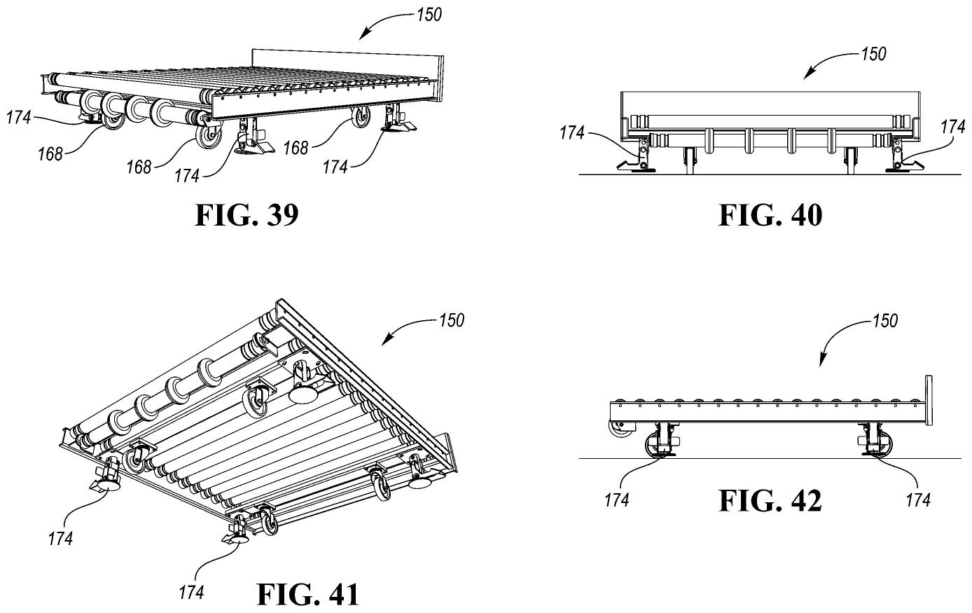

FIGS. 39 to 42 show the build platform 150 in more detail. Specifically, casters 168 (or other wheels) are provided below the base 152, but in use are suspended above the floor by floor locks 174, as shown. If it is desired to move the first alternative build platform 150, then the floor locks 174 can be released so that the casters 168 contact the floor and the build platform 150 can be rolled to another location.

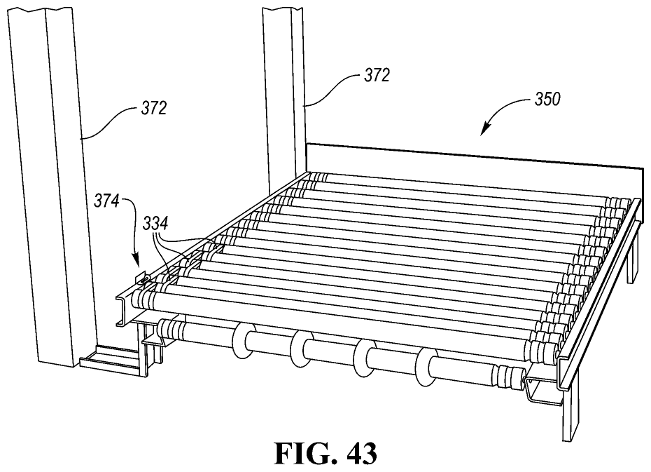

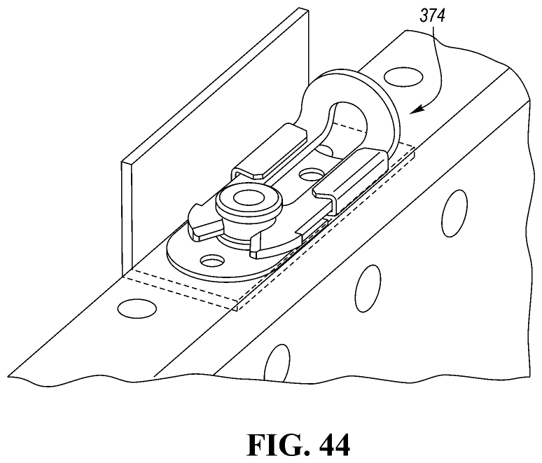

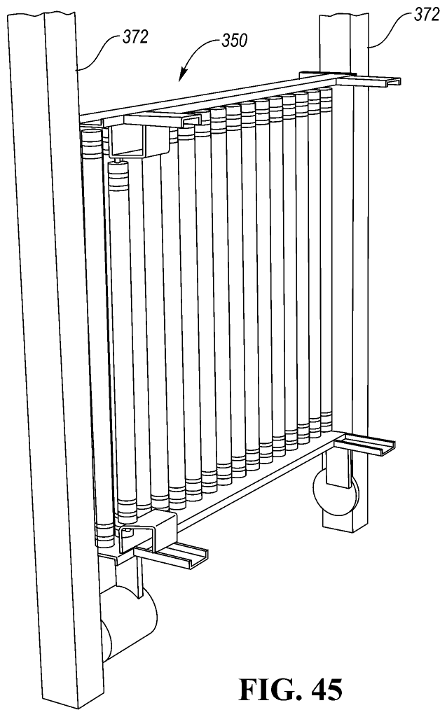

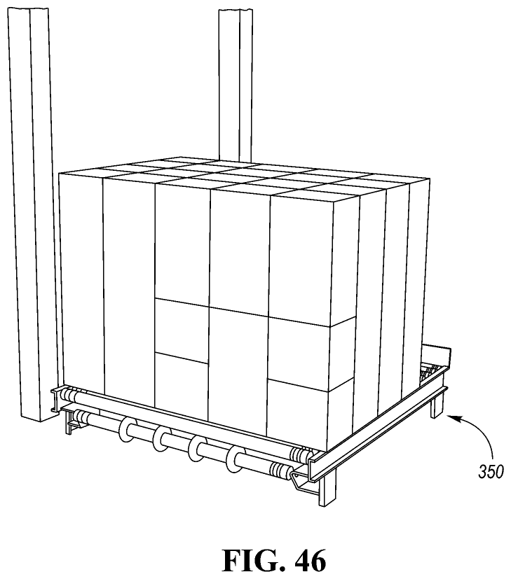

FIGS. 43-46 show an alternative build platform 350. The alternative build platform 350 is identical to the build platform 150 except as shown or described. Specifically, one side of the alternative build platform 350 is pivotably connected to posts 372. After releasing a quick release pin and bracket 374 (FIG. 39), the alternative build platform 350 can be flipped up to a vertical orientation parallel to the posts 372 as shown in FIG. 40. To use, the alternative build platform 350 can be pivoted downward onto the floor and stacked with plurality of items 180, as shown in FIG. 46.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claim steps are for ease of reference in dependent claims only and do not signify a required sequence of steps unless other explicitly recited in the claims.

What is claimed is:

1. A lift comprising:
a platform, the platform including a plurality of rollers rotatable about a horizontal roller axis; and
a pair of load wheels supporting the platform, each of the load wheels having a horizontal load wheel axis about which the load wheel rotates, wherein the horizontal load wheel axes are parallel to the horizontal roller axes.

2. The lift of claim 1 wherein the plurality of rollers are powered to move a load placed thereon.

3. The lift of claim 2 wherein the plurality of rollers includes a first roller having a hub motor therein.

4. The lift of claim 3 wherein the plurality of rollers are interconnected such that each of the plurality of rollers is rotatably coupled to an adjacent one of the plurality of rollers.

5. The lift of claim 4 in combination with a plurality of objects supported on the plurality of rollers.

6. The lift of claim 5 wherein the plurality of objects directly contact the plurality of rollers.

7. The lift of claim 4 wherein the plurality of rollers includes a forward-most roller offset downwardly relative to at least a subset of the plurality of rollers, which are substantially coplanar.

8. The lift of claim 1 further including a lower structure, wherein the pair of load wheels support the lower structure, wherein the platform is pivotable relative to the lower structure, the lift further including a tilt actuator configured to pivot the platform relative to the lower structure.

9. The lift of claim 8 further including:
a base, the lower structure extending forward of the base; and
a backrest fixed relative to the platform, the base pivotably connected to the base at a backrest axis spaced vertically higher than the platform.

10. The lift of claim 8 wherein the lower structure includes a rear portion extending substantially horizontally and a forward portion angling downward from a forward end of the rear portion.

11. The lift of claim 8 further including:
a base, the lower structure extending forward of the base;
a rear wheel supporting the base; and
a tiller arm configured to pivot the rear wheel about a vertical axis.

12. The lift of claim 11 further including a hub motor within the rear wheel.

13. The lift of claim 1 further including a rear wheel, the lift further including a tiller arm configured to pivot the rear wheel about a vertical axis.

14. The lift of claim 1 wherein the plurality of rollers includes a forward-most roller offset downwardly relative to at least a subset of the plurality of rollers, which are substantially coplanar.

15. The lift of claim 1 wherein the platform is pivotable between a lowered position in which the platform is tilted forward relative to a floor on which the lift is supported and a raised position in which the platform is tilted rearward relative to the floor.

16. A build platform comprising:
a base; and
a plurality of rollers rotatably supported on the base, each of the plurality of rollers rotatable about its longitudinal axis, wherein each longitudinal axis of the plurality of rollers is parallel to one another, wherein the plurality of rollers are configured to rotate together in a same rotational direction.

17. The build platform of claim 16 wherein the plurality of rollers are free-spinning about their longitudinal axes.

18. The build platform of claim 17 wherein the plurality of rollers are interconnected such that each of the plurality of rollers is rotatably coupled to an adjacent one of the plurality of rollers.

19. The build platform of claim 18 further including a drive roller positioned at a forward end of the build platform below a forward-most one of the plurality of rollers, wherein the drive roller rotatably engages the forward-most one of the plurality of rollers.

20. The build platform of claim 19 in combination with a lift having a lift platform including a forward-most roller and a plurality of wheels supporting the platform, wherein the forward-most roller is configured to rotatably engage the drive roller of the build platform, such that rotation of the forward-most roller of the lift causes rotation of the plurality of rollers of the build platform.

21. A method for loading a lift including:
a) moving a lift into a position adjacent a build platform having a plurality of rollers supporting at least one item thereon; and
b) causing the plurality of rollers to rotate, thereby causing the at least one item to move from the build platform to the lift.

22. The method of claim 21 wherein the lift causes the plurality of rollers on the build platform to rotate.

23. The method of claim 21 further including providing energy from the lift to the plurality of rollers on the build platform to rotate.

24. The method of claim 22 further rotatably driving a drive roller of the build platform, wherein the drive roller is rotatably coupled to the plurality of rollers on the build platform.

25. The method of claim 21 further including:
c) after step b), moving the at least one item with the lift; and
d) after step d), pivoting a support platform of the lift to place the at least one item on a floor.

26. A method for moving at least one item with a lift including:
a) placing the at least one item on a plurality of rollers on the lift;
b) moving the at least one item with the lift;
c) tilting the plurality of rollers relative to a floor; and
d) causing the plurality of rollers to rotate to move the at least one item off the lift.

27. The method of claim 26 wherein the at least one item is placed directly on the rollers in step a).

28. The method of claim 26 wherein step b) includes rolling the lift.

29. The method of claim 26 wherein step d) is performed by a motor.
